(19) United States
(12) Patent Application Publication
(10) Pub. No.: US 2007/0056334 A1
(43) Pub. Date: Mar. 15, 2007

(54) Security camera system for remote unsecured extended service

(76) Inventor: James Nelson Stevens, Weaverville, CA (US)

Correspondence Address: James Nelson Stevens, 501 Bonnie Way Democrat Gulch, POB 805, Weaverville, CA, 96093-0805, US

(21) Appl. No.: 11/515,271

(22) Filed: Sep. 1, 2006

Related U.S. Application Data
(60) Provisional application No. 60/716,242, filed on Sep. 13, 2005.

(51) Int. Cl. E05B 65/00

(52) U.S. Cl. 70/57

(57) ABSTRACT

This is a practically indestructible security camera system that stores discrete images virtually indefinitely. It is the only bullet-proof, theft-proof, vandal-proof, fraud-proof, fire-proof, self-sufficient, stand-alone security camera system extant. Self-analysis reporting and service and operations are managed remotely through any convenient phone or radio service. It provides a secure forensic record of vehicles, persons, animals, objects entering and exiting a designated area. It precludes criminal opportunism. It ameliorates illegal dumping. It augments police presence and minimizes victim crime in low police service areas.

### CROSS-REFERENCE TO RELATED APPLICATIONS

This application is entitled to the benefit of Provisional Patent Application No. 60/716,242, filed Sep. 13, 2005.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

Security cameras are a recent advent, having come into common use at the very end of the Twentieth Century. The security camera market therefore is young and robust and inherently focused on the low hanging fruit. Consequently, security camera providers have avoided addressing the difficult and extreme security setting.

Security cameras are necessarily always located in situations that inherently provide security for the cameras themselves. Security cameras, if not secreted from view or specifically secured by personnel, are invariably located within structures and buildings and other enclosures or hung high on poles and aerial wires and on the roofs and sides of buildings and other structures. Without external security, security cameras are vulnerable to fraud, vandalism, theft and other interventions.

The prior art of security camera hardening consists of metal camera housings that can, except for the lens openings, withstand small arms fire, and transparent plastic domes for cameras and lenses that can withstand moderately severe impact. Neither plastic domes not bulletproof housings can protect against fraud, vandalism and theft, not are they capable of withstanding determined attack. Both of these security advents for security cameras require additional security.

As of this writing, there is no such thing as a bullet-proof, theft-proof, vandal-proof, fraud-proof, fire-proof, stand-alone, self-sufficient, autonomous security camera system designed for unattended long-term service in unsecured deserted settings. The demand for such an instrument is prevalent and long standing and, specifically, unmet.

### BRIEF SUMMARY OF THE INVENTION

This security camera system provides a hardened surveillance system that photographs a predetermined subject as it nears or passes the installation and stores the image for a predetermined (technically unlimited) time.

Stored images may be recovered and viewed at any time, especially should there occur a significant event or a predetermined event or a relative event such as a crime.

The security system cannot be moved without heavy equipment and is impervious to, among other things, spray paint, chainsaws, sledge hammers, wheeled vehicles and projectiles thrown by any non-military implements, including, but not limited to, bullets, arrows, crossbow bolts, and paintballs.

### BRIEF DESCRIPTION OF THE SEVERAL VIEWS OF THE DRAWING

Not applicable.

### DETAILED DESCRIPTION OF THE INVENTION

The preferred embodiment of the invention described herein is an armored Tube 1 that sticks vertically out of the ground at the side of a road that, through internal mechanism, takes a picture of every vehicle, etcetera, that passes and stores the image indefinitely for future reference. A road sign placed near the system informing the driver that he or she has been photographed precludes criminal opportunism.

Tube 1 is heavy-walled material of sufficient strength to deflect bullets without interior damage and to resist bending without heavy equipment, and of an interior dimension sufficient to contain the electrical, electronic, and mechanical elements of the system. (A cannon barrel is a good example.)

Tube 1, with bottom sealed to prevent infiltration of water and concrete, is installed vertically in a bed of Reinforced Concrete 2, upper surface of Concrete 2 approximately flush with surface of the earth, upper, open, portion of Tube 1 extending sufficiently high to provide unrestricted 360 degree access of pertinent surroundings.

Concrete 2 bed may be of any configuration provided it has sufficient mass to require heavy construction or deconstruction equipment to disassemble or move. The preferred embodiment is a vertical bore into the earth sufficiently wide to surround, encompass, and embrace lower portion of Tube 1 within Concrete 2 sufficient to provide required immobility and sufficiently deep to provide required mass,

Ducting for power and signal inputs and outputs enter bottom of Tube 1 through Concrete 2 bed.

A Cap 3 with impact resistance equivalent to Tube 1 and dimensioned to fit easily and smoothly over the top open end of Tube 1 will mount over the top of Tube 1. Cap 3 is electrically isolated from Tube 1 to serve as radio antenna.

Operational elements exterior to Tube 1;

A. Plurality of Remote Vehicle Sensors located relative to roadway at determined locations,

B. Plurality of Remote Personnel Sensors located relative to Tube 1 at determined locations,

C. External Power Source.

Operational elements located within Tube 1;

a. Electronic Camera, sensitive to both visual and infrared light,

b. Optical Lens, to focus image on camera (a) light receptor,

c. Optical Mirrors, to provide 360-degree view of surrounds to camera (a),

d. Flash, infrared light,

e. Flash, visible light,

f. Data Processor (CPU),

g. Data Storage Device,

h. Electro-Mechanical Means, locks/unlocks/raises/lowers Cap 3,

i. Radio Transmitter/Receiver,

j. Power Regulator/Controller.

k. Heater, electric,

l. Battery, rechargeable.

Optical Mirrors (c) are located at upper top open end of Tube 1 and are exposed when Cap 3 is elevated. All other internal elements are located at the lower bottom closed end of Tube 1, whereby encased within Concrete 2 for fire protection.

All internal and external operation elements are commercially available in part and in whole, are comprised of commercially available materials, and are readily designed and constructed from commonly available parts, plans, and schematics by anyone familiar with the technology.

### OPERATION OF PREFERRED EMBODIMENT

Remote Vehicle Sensors (A) detect approaching vehicles and provide data to Data Processor (f). Processor (f) instructs Electro-Mechanical Means (h) to raise Cap 3 to expose Optical Mirrors (c), focusing targeted vehicle image through Optical Lenses (b) onto light receptor of Camera (a). Processor (f) further instructs Camera (a) and infrared Flash (d), as required, to operate to capture targeted vehicle image and store the image, with time and date, in Data Storage Device (g). Infrared Flash (d) provides vision through smoke, fog, rain, snow, and does not blind drivers. Processor (f) then causes E/M Means (h) to close Cap 3. Cap 3 is opened only for the microseconds required to capture image.

Remote Personnel Sensors (B) detect approaching pedestrians and provide data to Processor (f). Processor (f) instructs E/M Means (h) to raise Cap 3 to expose Mirrors (c) focusing targeted personnel image through Lens (b) to light receptor of Camera (a). Processor (f) further instructs Camera (a) and visible Flash (e), as required to operate to capture targeted personnel image and store the image, with time and date, in Data Storage (g). Visible Flash (e) signifies to intruders that they have been photographed. Processor (f) then instructs E/M Means (h) to lock Cap 3 tightly down to the top of Tube 1 for the duration of the personnel intrusion presence preventing access and the introduction of gases, vapors, liquids.

Radio Transmitter (i) serves to request service, download service data and upload images.

Power Regulator/Controller (j) stabilizes and distributes power where and as required.

Heater (k) maintains internal temperature to prevent seizure and damage from external cold environment.

Battery (l) is constantly charged from External Power Source C and provides backup power during Power C interruption events.

1. A security camera system enclosed within a housing that is impossible to damage or move without the use of heavy equipment for use in remote unsecured locations
